(19) United States
(12) Patent Application Publication
(10) Pub. No.: US 2005/0141108 A1
(43) Pub. Date: Jun. 30, 2005

(54) Cryogenic telescope using hybrid material for thermal stability

(76) Inventors: Charles B. Atkinson, Redondo Beach, CA (US); Larry N. Gilman, Inglewood, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 09/948,287

(22) Filed: Sep. 6, 2001

(51) Int. Cl. G02B 7/02

(52) U.S. Cl. 359/820

(57) ABSTRACT

A large, deployable space telescope (1) includes an optical system element (4) and a support structure (5) supporting the optical system element. The support structure is formed of a composite material (10) of boron and carbon fibers in a plastic resin matrix. The composite support structure has a net coefficient of thermal expansion within ±0.1 ppm/K at temperatures below 75K which enables diffraction limited performance of the telescope under cryogenic operational temperature variations.

### BACKGROUND OF THE INVENTION

1. Technical Field

The present invention relates to a cryogenic optical system. More particularly, the invention concerns a large, deployable space telescope which is cost effectively, thermally stable during operation at cryogenic temperatures to achieve diffraction limited performance while mitigating the need for expensive thermal or wavefront control systems.

2. Background

To achieve diffraction limited performance in a telescope system, thermally stable materials need to be used to ensure alignments and distortions are kept to a minimum. At cryogenic temperatures, achieving thermally stable structures for optical systems has traditionally relied on beryllium, as it is known to have very low coefficient of thermal expansion at cryogenic temperatures. However, beryllium is expensive and is an environmental hazard.

Composites have been shown to behave in a thermally stable manner at room temperature and have been used in many optical systems that operate at room temperature. The problem with using traditional composite designs for cryogenic optical systems is that their coefficient of thermal expansion (CTE) starts to get too large below 75K. Typical CTE plots for standard composites, M55J carbon fiber, made by Toray Industries, in resin matrix composites, versus a minimum desired CTE range are shown in FIG. 1. The carbon fibers in the three standard composites measured in FIG. 1 were M55J in three different layups. The desired CTE range, within ±0.1 ppm/K at temperatures below 75K, shown in FIG. 1 is that desired for thermal stability in optic systems operating at cryogenic temperatures. Such thermal stability has traditionally been achieved using beryllium as noted above.

Hybrid laminated composites of boron fiber and carbon fiber in resin matrix are, per se, known. Several have been disclosed by Pollatta et al. for room temperature optical system support structures. See U.S. Pat. Nos. 5,554,430 and 5,593,752. However, from the traditional rule of mixtures it would not be expected that these materials would have the desired thermal stability at cryogenic temperature for use in cryogenic optical systems.

### SUMMARY

The present invention avoids these drawbacks and limitations of the prior art cryogenic optical systems. More particularly, the present invention provides an improved cryogenic optical system comprising an optical system element, a support structure supporting the optical system element, and wherein the support structure is formed of a composite material having a coefficient of thermal expansion within ±0.1 ppm/K at temperatures below 75K. In the disclosed example embodiment, the cryogenic optical system is a large, deployable space telescope having a support structure formed of a hybrid laminate composite of boron and carbon fibers in an isotropic layer in a plastic resin matrix. The support structure advantageously has a thermal stability which enables performance of the telescope to remain diffraction limited under cryogenic operational temperature variations without necessitating use of an expensive thermal control system.

These and other features and advantages of the invention will be more clearly understood and appreciated from a review of the following detailed description of the disclosed example embodiment and appended claims, and by reference to the accompanying drawings.

### BRIEF DESCRIPTION OF THE DRAWINGS

FIG. 1 is a graph of the coefficient of thermal expansion (CTE) for standard composite materials as a function of temperature, shown in comparison to a desired CTE range for cryogenic optical systems.

FIG. 2 is an exploded view of a deployable optical space telescope according to an example embodiment of the invention.

FIG. 3 is a front side view of the backplane for the primary mirror of the space telescope of FIG. 2.

FIG. 4 is a right side view of the backplane of FIGS. 2 and 3 and showing the backplane support frame of the telescope attached thereto.

FIG. 5 is a perspective view from the side and above of the telescope, partially broken away, showing primary mirror segments mounted on the backplane and depicting the secondary mirror in relation to the primary mirror.

FIG. 6 is a graph of the results of cryotesting of a prototype support structure for the cryogenic telescope of FIGS. 2-5 versus test results for standard composite material (M55J composite coupons).

FIG. 7 is a schematic drawing of the layup for the hybrid composite laminate material of the support structure of the telescope of FIGS. 2-5.

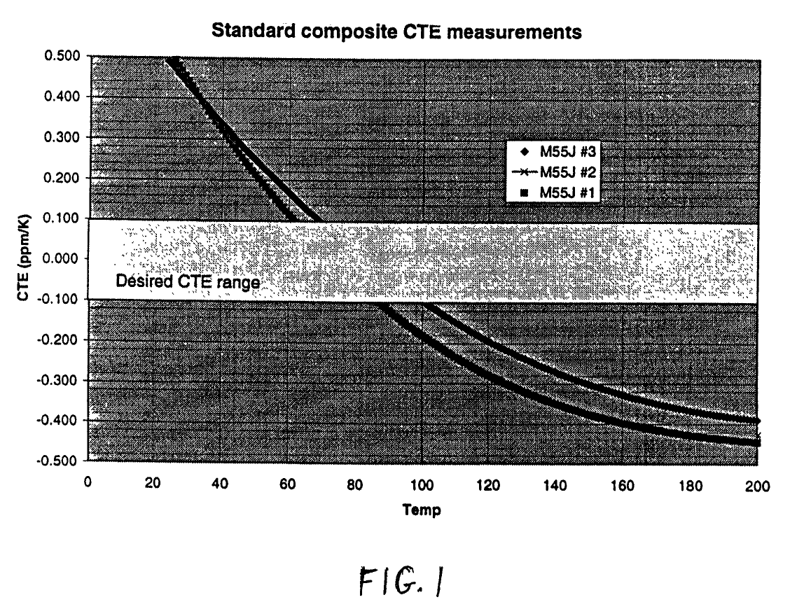

### DETAILED DESCRIPTION

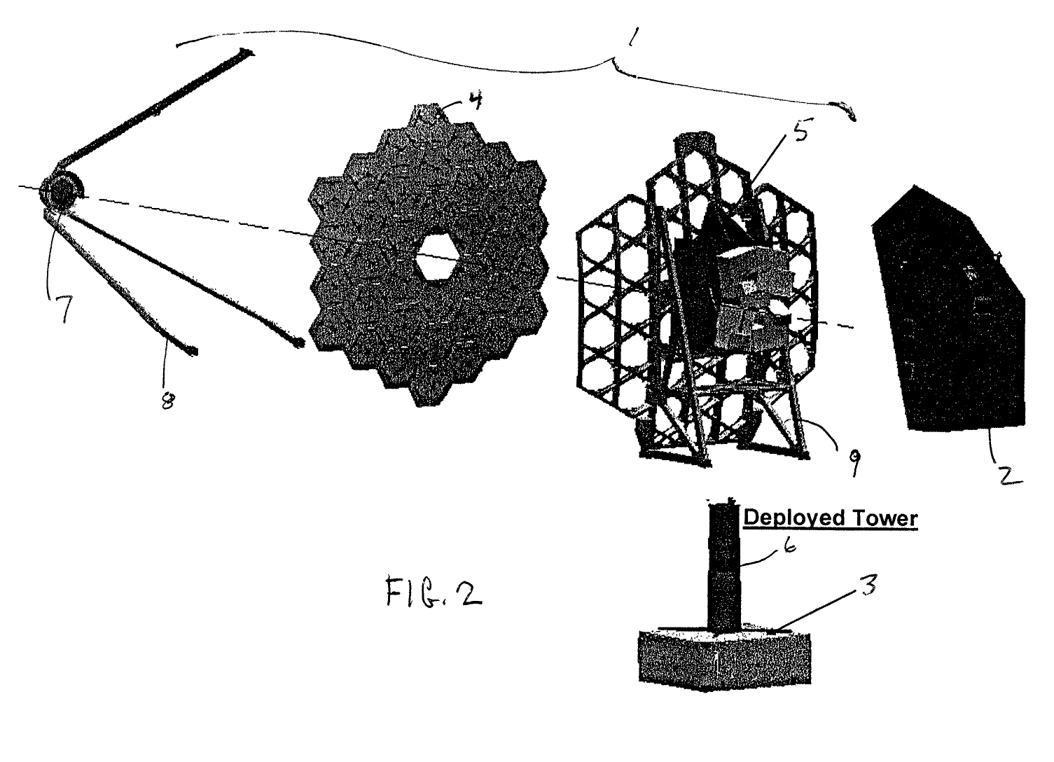

Referring now to the drawings, the cryogenic telescope 1 of the example embodiment as shown in FIGS. 2-5 is part of a space observatory having three elements: the optical telescope element 1, an integrated science instrument module element 2, and a spacecraft element formed of a spacecraft bus 3 supporting elements 1 and 2 by way of a tower 6. The observatory also includes a sun shield, not shown. Semi-rigid mirror segments 4 of the primary mirror of the telescope 1 are mounted on a very stable and rigid backplane composite structure 5 according to the invention. The semi-rigid mirror segments are formed of beryllium or fused silica which are adjustably mounted by actuators on the backplane composite structure 5. The modest amount of flexibility of each mirror segment allows for on-orbit compensation of segment-to-segment radius of curvature variations due to manufacturing errors. Rigid body (tip-tilt-descent) adjustment of individual mirrors permits wave front control to achieve a diffraction-limited large aperture telescope after deployment. The aperture of the telescope in the example embodiment is preferably 6 meters or greater.

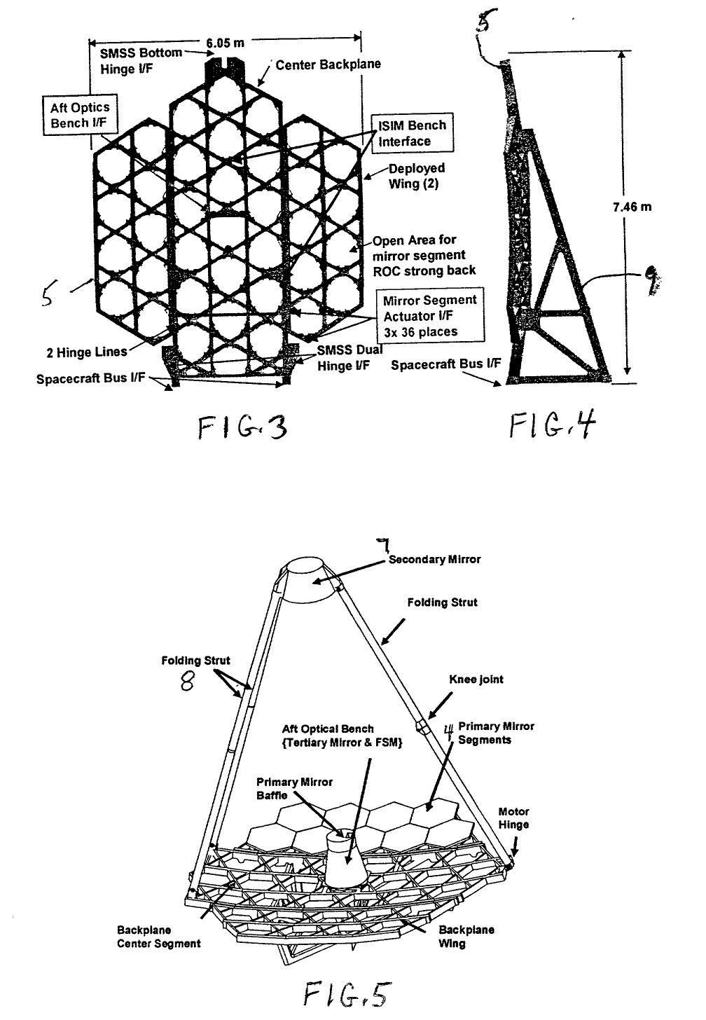

The primary mirror has a two chord fold architecture with two deployed wings foldable relative to a center backplane by hinge lines, see FIG. 3. Thermal straps are provided across the hinge lines for achieving uniform temperature distribution on the primary mirror structure. With these features and the sun shield, the cryogenic telescope 1 and instrument module 2 can be maintained at very stable cryogenic conditions in space without relying on active thermal control or active wave front control. In the deployed position of the telescope in space, the tower 6 is extended to separate the spacecraft from the telescope.

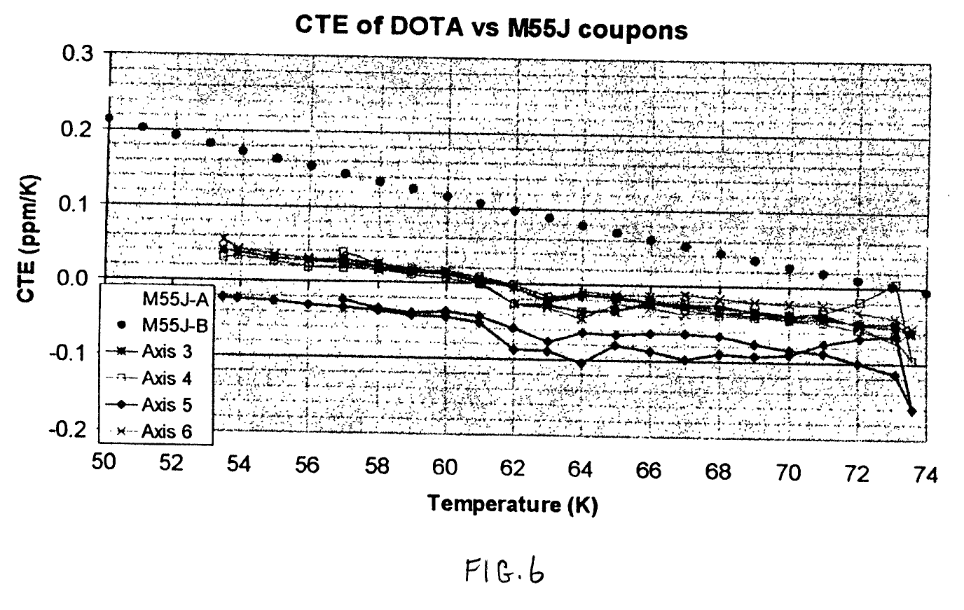

The optical telescope 1 in the example embodiment has a 29.4 square meter collecting area, with a three mirror anastigmatic optical design. It provides an angular resolution of 71 milli-arcseconds at wavelength λ=2 micrometers and allows for nano-Jansky sensitivity. The secondary mirror 7 of the telescope is supported by a deployable tripod support structure 8 from the backplane center segment, see FIG. 5. In order to attain this high level of performance, a thermally stable support structure is required for this telescope. In this regard, the primary mirror backplane 5 is the integrating structure for the telescope. It serves several key functions: the support structure for the primary segments; the supporting base for the secondary mirror support structure; and the structural interface for the integrated science instrument module element 2. It also provides primary mirror deployment components and attachments for an aft optical bench.

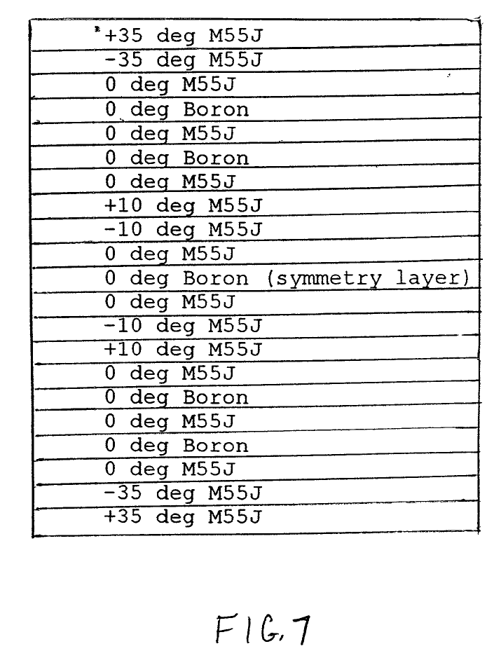

To this end, the backplane structure 5 according to the invention is fabricated of a composite material 10 of boron and carbon fibers in a layup as depicted in FIG. 7 with a plastic resin matrix, the support structure having a net coefficient of thermal expansion within ±0.1 ppm/K at temperatures below 75K. It has been found that this telescope support structure provides a superior stiffness and allows for meeting observatory, thermo-mechanical-optical requirements. The laminate layup provides the necessary low coefficient of thermal expansion at the cryogenic operating temperature and it does this at a lower cost than beryllium.

FIG. 7 is a schematic cross-section of a layup of boron and carbon fiber plies in a laminate according to the present invention. More particularly, the layup consisted of 0.0033 inch plies of M55J/954-6 carbon fiber from Textron, 0.004 inch thick plies of boron/954-6 from Textron, and resin film, specifically a polycyanate ester resin film, MJSP98 954-6 resin film from Hexcel. The arrangement of the plies of material in the layup and their angles with respect to the axial direction are shown in FIG. 7. The higher angle carbon fiber plies in the layup, within the range of ±10°-35°, help achieve the lowest CTE at cryogenic temperatures in consideration of the Poisson's ratios. The multi-layer laminate was co-cured using standard composite curing techniques. Surprisingly, this combination of materials in the composite used to construct the telescope structure, including the backplane composite structure 5 as well as the tripod support structure 8 and backplane support frame 9 resulted in a lower CTE material at cryogenic temperatures (below 75K) than is seen with other composites. As an explanation, it is noted that the Poissons' ratio of boron material creates a condition whereby the interaction of the thermally induced forces of the different materials in the composite, that occur as a result of operating cryogenically, alters the expected thermal strain. This altered thermal strain results in a net CTE for the material that is better than expected when used at cryogenic temperatures.

This lower CTE of the telescope supporting structure, when used at cryogenic temperatures, enables the telescope to be thermally stable, therefore maintaining diffraction limited under operational temperature variations. This was demonstrated from cryogenic tests on a prototype structure for the cryogenic telescope. The results of these measurements are depicted in FIG. 6 where they are shown in comparison with the measured results of standard composites of M55J carbon fiber in resin matrix. As seen from FIG. 6, the improved telescope structure of the present invention proves to have 3× better CTE than M55J (0.1 versus 0.35 ppm/K). The result of the combination of materials in the telescope support structure in the present invention is a lower CTE than the rule of mixtures would predict.

The measurements taken on the large prototype structure showed that a CTE of less than 0.1 ppm/K can be achieved in an integrated structure. When this material and it's inherent CTE is applied to a cryogenic optical system, very stable thermal performance is attained. By avoiding the need to use a beryllium, telescope support structure, the cost can be reduced. Alternative cryogenic telescope designs that use other composites can be made diffraction limited by applying tighter thermal control to alleviate the higher CTE. However, the present invention alleviates the need for very tight thermal control, either through passive or active means, which also aids in reducing cost.

While the subject invention has been described with reference to the example embodiment, various other changes and modifications could be made therein by one skilled in the art without varying from the scope or spirit of the subject invention as defined in the appended claims.

1. A cryogenic optical system comprising:
an optical system element;
a support structure supporting the optical system element, and
wherein the support structure is formed of a composite material having a coefficient of thermal expansion within ±0.1 ppm/K at temperatures below 75K.

2. The cryogenic optical system according to claim 1, wherein the optical system is a space telescope.

3. The cryogenic optical system according to claim 2, wherein the space telescope is a deployable space telescope having an aperture of at least 6 meters.

4. The cryogenic optical system according to claim 1, wherein the composite material has a negative coefficient of thermal expansion down to 50K.

5. The cryogenic optical system according to claim 1, wherein the support structure has a stability which enables performance of the optical system to remain diffraction limited under cryogenic operational temperature variations.

6. The cryogenic optical system according to claim 1, wherein the composite material is a hybrid, laminate material comprising boron fiber and carbon fiber in a resin matrix.

7. The cryogenic optical system according to claim 6, wherein the carbon fiber comprises carbon fiber plies arranged with respect to the axial direction of the laminate within the range ±10-35°.

8. The cryogenic optical system according to claim 1, wherein the support structure is a primary mirror backplane of a space telescope.

9. The cryogenic optical system according to claim 1, wherein the support structure is a secondary mirror support structure of a space telescope.

10. The cryogenic optical system according to claim 1, wherein the support structure is a support frame for a primary mirror backplane of a space telescope.

11. A cryogenic telescope comprising:
an optical system element;
a support structure supporting the optical system element, and
wherein the support structure is formed of a composite material of boron and carbon fibers in a plastic resin matrix, the support structure having a net coefficient of thermal expansion within ±0.1 ppm/K at temperatures below 75K.

12. The space telescope according to claim 11, wherein the composite material has a negative coefficient of thermal expansion down to 50K.

13. The space telescope according to claim 11, wherein the telescope is a deployable space telescope having an aperture of at least 6 meters.

14. The space telescope according to claim 11, wherein the support structure has a stability enabling performance of the telescope to remain diffraction limited under cryogenic operational temperature variations.

15. The space telescope according to claim 11, wherein the support structure is a primary mirror backplane of the telescope.

16. The space telescope according to claim 11, wherein the support structure is a secondary mirror support structure of the telescope.

17. The space telescope according to claim 11, wherein the support structure is a support frame for a primary mirror backplane of the telescope.

18. The space telescope according to claim 11, wherein the carbon fiber comprises carbon fiber plies arranged with respect to the axial direction of the laminate within the range of ±10-35°.

19. A method of supporting a cryogenic optical system element at cryogenic temperatures, comprising:
providing a support structure for a cryogenic optical system element; and
supporting the optical system element with the support structure at temperatures below 75K;
wherein the support structure is formed of a composite material of boron and carbon fibers in a plastic resin matrix, the support structure having a net coefficient of thermal expansion within ±0.1 ppm/K at temperatures below 75K.

20. The method according to claim 19, wherein the stability of the support structure enables performance of the optical system to remain diffraction limited under cryogenic operational temperature variations.
